(19) United States
(12) Patent Application Publication
(10) Pub. No.: US 2014/0071860 A1
(43) Pub. Date: Mar. 13, 2014

(54) Setting Timers when Using Radio Carrier Aggregation

(71) Applicant: Telefonaktiebolaget LM Ericsson (publ), Stockholm (SE)

(72) Inventors: Riikka Susitaival, Helsinki (FI); Mikael Wittberg, Uppsala (SE)

(73) Assignee: Telefonaktiebolaget LM Ericsson (publ), Stockholm (SE)

(21) Appl. No.: 13/696,435

(22) PCT Filed: Sep. 25, 2012
(86) PCT No.: PCT/SE2012/051014

§ 371 Date: Nov. 6, 2012

Related U.S. Application Data
(60) Provisional application No. 61/592,100, filed on Jan. 30, 2012.

(51) Int. Cl. H04B 7/26

(52) U.S. Cl. CPC H04B 7/26
USPC 370/280

(57) ABSTRACT

The present invention relates to a method of a user equipment (UE) using discontinuous reception (DRX) and time division duplex (TDD) carrier aggregation of at least a first and a second cell, the first cell 501 having an UL-DL configuration of uplink (UL) and downlink (DL) subframes 503 which is different from such an UL-DL configuration of the second cell 502. The method comprises setting a first DRX timer 505, the duration of which is dependent on UL-DL configurations of a plurality of aggregated cells, including the first and second cells, such that the duration of the first timer corresponds to a first number of subframes where at least one of the plurality of aggregated cells has a DL subframe. The method also comprises setting a second DRX timer 506, the duration of which is dependent on the UL-DL configuration of a single one of the aggregated cells, such that the duration of the second timer corresponds to a second number of subframes where said single one of the cells has a DL subframe.

### TECHNICAL FIELD

The invention relates to a method and a device using discontinuous reception (DRX) and time division duplex (TDD) carrier aggregation (CA) of at least a first and a second cell, the first cell having an UL-DL configuration of uplink (UL) and downlink (DL) subframes which is different from such an UL-DL configuration of the second cell.

### BACKGROUND

Transmission and reception from a node, e.g. a terminal in a cellular system such as Third Generation Partnership Project (3GPP) Long Term Evolution (LTE) can be multiplexed in the frequency domain or in the time domain (or combinations thereof). Frequency Division Duplex (FDD) as illustrated in the left hand side of FIG. 1 implies that downlink and uplink transmission take place in different, sufficiently separated, frequency bands. Time Division Duplex (TDD), as illustrated to the right in FIG. 1, implies that downlink and uplink transmission take place in different, non-overlapping time slots. Thus, TDD can operate in unpaired spectrum, whereas FDD requires paired spectrum.

Typically, the structure of the transmitted signal in a communication system is organized in some form of frame structure. For example, LTE uses ten equally-sized subframes of length 1 millisecond (ms) per radio frame as illustrated in FIG. 2. Again, the difference between FDD, illustrated in the top of FIG. 2, where a paired spectrum is used for UL and DL, and TDD, illustrated at the bottom of FIG. 2, where an unpaired spectrum is used and UL and DL are configured in different time slots, in LTE called subframes, in a radio frame.

An aspect of any TDD system is to provide the possibility for a sufficiently large guard time where neither downlink nor uplink transmissions occur. This is required to avoid interference between uplink and downlink transmissions due to propagation delays, and to allow the equipment to switch between receive and transmit. For LTE, this guard time is provided by special subframes (subframe 1 and, in some cases, subframe 6). The special subframes are split into three parts: a downlink part (downlink pilot time slot, DwPTS), a guard period (GP), and an uplink part (uplink pilot time slot, UpPTS). The remaining subframes are either allocated to uplink or downlink transmission. The DwPTS part of the special subframe is used for Physical Downlink Control Channel (PDCCH) and Physical Downlink Shared Channel (PDSCH) transmissions, whereas the UpPTS part of the special subframe is used only for random access preamble transmission on the Physical Random Access Channel (PRACH), and for sounding, i.e., Sounding Reference Signal (SRS).

TDD allows for different asymmetries in terms of the amount of resources allocated for uplink and downlink transmission, respectively, by means of different UL-DL configurations. In LTE, there are seven different TDD configurations as shown in FIG. 3. The configurations cover a wide range of allocations from uplink heavy DL:UL ratio 2:3 (Configuration 0) to downlink heavy DL:UL ratio 9:1 (Configuration 5). The special subframe 1, and subframe 6 in configurations 0, 1, 2 and 6 are here regarded as DL subframes.

Discontinuous Reception (DRX) in the RRC_CONNECTED state, i.e. when the Radio Resource Control (RRC) protocol is active, is described in section 5.7 of the 3GPP LTE Media Access Control (MAC) specification 36.321. The main agreed principle of DRX is that similar procedures are used both for the uplink and for the downlink. The RRC protocol activates the DRX mechanism of a given user and defines the beginning of the DRX cycle by configuring an offset value. The User Equipment (UE) shall monitor the PDCCH during DRX Active Time. Regardless of Active time, the UE should transmit or receive Hybrid Automatic Repeat Request (HARQ) feedback when such is expected. The Active Time includes time when at least one of the following conditions is fulfilled:

1. When the On Duration Timer is running. In the beginning of each DRX cycle, the On Duration Timer defines how long the UE should monitor PDCCH and be active. There are two types of cycles, long and short. Short cycles are followed only when there has recently been activity and long cycles are used otherwise.
2. When the Inactivity Timer is running. When the PDCCH indicates a new transmission in DL or UL, that is, a DL assignment or an UL grant, the Inactivity Timer is (re-)started.
3. When a Scheduling Request is pending. After sending a scheduling request, the UE expects the evolved Node B (eNB) to schedule it and send an UL grant on PDCCH.
4. When the Retransmission Timer is running. In downlink, the retransmissions are asynchronous and they do not always need to be done one HARQ round trip time (RTT) after the previous transmission as is done in uplink. Thus, when the UE receives a DL transmission, it starts a DL HARQ RTT Timer for the current HARQ process. When this timer expires, the Retransmission Timer of the HARQ process is started and the UE monitors the PDCCH for incoming assignments. The Retransmission Timer is started only when the UE has not been able to decode the DL data and thus has sent a negative acknowledgement in the uplink.
5. When an uplink grant for a retransmission may occur. In LTE, the eNB may send a new UL resource allocation together with the HARQ feedback to be used for the retransmission. Note that during this subframe, 4 ms after the initial UL transmission, the UE should not only monitor the PDCCH for uplink grants but also the Physical HARQ Indicator Channel (PHICH) for the HARQ feedback.
6. When an UL grant is expected after receiving a Random Access Response, or when the Contention Resolution Timer is running.

In 3GPP LTE MAC specification 36.321, it is specified that when counting the length of the timer, the PDCCH subframe is taken into account. A PDCCH subframe can be a normal DL subframe or a special subframe including DwPTS in TDD. An UL subframe cannot be a PDCCH subframe.

In carrier aggregation, one or more component carriers are aggregated together for a single UE to obtain a wider bandwidth up to 100 MHz and higher bit rates up to 3 Gbps, according to current LTE standard. The UE has one primary cell (PCell) and one ore more serving cells (SCell), “cell” and “carrier” being used interchangeably. The serving cell SCell is also commonly named secondary cell. The network configures the PCell and SCells with RRC.

An SCell can be activated or deactivated, and the activation state is controlled by MAC Control Elements (MAC CEs) and timers. In 3GPP Release ten (Rel-10), cross-carrier scheduling was also introduced, meaning that one cell may carry scheduling information on PDCCH for another cell. The scheduling cell of the serving cell is configured semi-statistically with RRC.

In LTE Rel-10, there is one DRX mechanism including one set of DRX timers for all cells. This means that when in DRX activate time, the UE should monitor PDCCH of all activated cells. Furthermore, if e.g. the DRX Inactivity Timer is started due to a new transmission in one cell, the UE needs to monitor the PDCCH in all cells.

Considering TDD operation, in Rel-10, only carrier aggregation in one frequency band is supported and all aggregated cells should have the same TDD configuration (see configurations in FIG. 3). This means that UL and DL directions are the same in all cells concurrently. However, in the 3GPP Radio layer 1 meeting number 66bis (RAN1#66bis meeting), RAN1 has agreed to support different TDD configurations for inter-band carrier aggregation. This means that one cell/carrier can be in UL state whereas another cell/carrier is in DL state at the same time.

Currently DRX timers are specified in terms of PDCCH subframes. When UL and DL subframes overlap, it is not clear how to handle these timers. This issue has been discussed in 3GPP Radio layer 2 (RAN2) contribution R2-115823, “DRX operation with different TDD UL/DL configurations”, Asustek, Nokia Siemens Networks, Nokia Corporation, San Francisco, November 2011. In this contribution, it is proposed that when running DRX timers, a subframe that is PDCCH subframe in any aggregated carrier, i.e, union over DL and DwPTS subframes, is counted as a PDCCH subframe.

### SUMMARY

The inventors have realised that there is a problem with the prior art which may limit the scheduling opportunities in aggregated cells where different cells have different UL-DL configuration, since not all cells may then be available for scheduling in the same subframe. It is an objective of the present disclosure to alleviate this problem.

According to an aspect of the present disclosure, there is provided a method of a user equipment (UE) using discontinuous reception (DRX) and time division duplex (TDD) carrier aggregation of at least a first and a second cell, the first cell having an UL-DL configuration of uplink (UL) and downlink (DL) subframes which is different from such an UL-DL configuration of the second cell. The method comprises setting a first DRX timer, the duration of which is dependent on UL-DL configurations of a plurality of aggregated cells, including the first and second cells, such that the duration of the first timer corresponds to a first number of subframes where at least one of the plurality of aggregated cells has a DL subframe. The method also comprises setting a second DRX timer, the duration of which is dependent on the UL-DL configuration of a single one of the aggregated cells, such that the duration of the second timer corresponds to a second number of subframes where said single one of the cells has a DL subframe.

According to another aspect of the present disclosure, there is provided a user equipment (UE) configured for using DRX and TDD carrier aggregation of at least a first and a second cell, wherein the first cell can have an UL-DL configuration of UL and DL subframes which is different from such an UL-DL configuration of the second cell. The UE comprises a processor, and a memory storing instructions that, when executed by the processor, cause the UE to set a first DRX timer, the duration of which is dependent on UL-DL configurations of a plurality of aggregated cells, including the first and second cells, such that the duration of the first timer corresponds to a first number of subframes where at least one of the plurality of aggregated cells has a DL subframe. The UE is also caused to set a second DRX timer, the duration of which is dependent on the UL-DL configuration of a single one of the aggregated cells, such that the duration of the second timer corresponds to a second number of subframes where said single one of the cells has a DL subframe.

According to another aspect of the present disclosure, there is provided a computer program product comprising computer-executable components for causing a UE to perform an embodiment of a method of the present disclosure when the computer-executable components are run on a processor comprised in the UE.

According to another aspect of the present disclosure, there is provided a computer program for a UE configured for using DRX and TDD carrier aggregation of at least a first and a second cell, wherein the first cell can have an UL-DL configuration of UL and DL subframes which is different from such an UL-DL configuration of the second cell. The computer program comprises computer program code which is able to, when run on a processor of the UE, cause the UE (605) to set a first DRX timer, the duration of which is dependent on UL-DL configurations of a plurality of aggregated cells, including the first and second cells, such that the duration of the first timer corresponds to a first number of subframes where at least one of the plurality of aggregated cells has a DL subframe. The code is also able to cause the UE to set a second DRX timer, the duration of which is dependent on the UL-DL configuration of a single one of aggregated cells, such that the duration of the second timer corresponds to a second number of subframes where said single one of the cells has a DL subframe.

According to another aspect of the present disclosure, there is provided a computer program product comprising an embodiment of a computer program of the present disclosure and a computer readable means on which the computer program is stored.

According to another aspect of the present disclosure, there is provided a method of a network node serving a UE using DRX and TDD carrier aggregation of at least a first and a second cell, the first cell having an UL-DL configuration of UL and DL subframes which is different from such an UL-DL configuration of the second cell. The method comprises setting a first DRX timer, the duration of which is dependent on UL-DL configurations of a plurality of aggregated cells of the UE, including the first and second cells, such that the duration of the first timer corresponds to a first number of subframes where at least one of the plurality of aggregated cells has a DL subframe. The method also comprises setting a second DRX timer, the duration of which is dependent on the UL-DL configuration of a single one of the aggregated cells of the UE, such that the duration of the second timer corresponds to a second number of subframes where said single one of the cells has a DL subframe.

According to another aspect of the present disclosure, there is provided a network node configured for serving a UE using DRX and TDD carrier aggregation of at least a first and a second cell, wherein the first cell can have an UL-DL configuration of UL and DL subframes which is different from such an UL-DL configuration of the second cell. The network node comprises a processor, and a memory storing instructions that, when executed by the processor, cause the network node to set a first DRX timer, the duration of which is dependent on UL-DL configurations of a plurality of aggregated cells of the UE, including the first and second cells, such that the duration of the second timer corresponds to a first number of subframes where at least one of the plurality of aggregated cells has a DL subframe. The network node is also caused to set a second DRX timer, the duration of which is dependent on the UL-DL configuration of a single one of the aggregated cells of the UE, such that the duration of the second timer corresponds to a second number of subframes where said single one of the cells has a DL subframe.

By setting a first DRX timer which is dependent on the union of DL subframes of the aggregated cells/carriers, and a second DRX timer which is dependent only on the DL subframes of a single one of the aggregated cells/carriers, the timers can be better optimised depending on the type of timer, since some timers are relevant for a plurality of the aggregated cells and some timers are only relevant for one of the aggregated cells. The present disclosure improves DRX efficiency in TDD inter-band carrier aggregation scenarios.

Similarly, according to another aspect of the present invention, there is provided a method of a UE using DRX and TDD carrier aggregation of at least a first and a second cell, the first cell having an UL-DL configuration of UL and DL subframes which is different from such an UL-DL configuration of the second cell. The method comprises setting a DRX timer, the duration of which is dependent on UL-DL configurations of a plurality of aggregated cells, including the first and second cells, such that the duration of the timer corresponds to a number of subframes where at least one of the plurality of aggregated cells has a DL subframe. According to this aspect, the carrier aggregation also comprises at least one cell which is not a scheduling cell, which cell is not included in the plurality of aggregated cells which the duration of the timer is dependent on. The non-scheduling cell may e.g. be a deactivated cell, or an otherwise not scheduling cell.

According to another aspect of the present disclosure, there is provided a UE configured for using DRX and TDD carrier aggregation of at least a first and a second, wherein the first cell can have an UL-DL configuration of UL and DL subframes which is different from such an UL-DL configuration of the second cell. The UE comprises a processor, and a memory storing instructions that, when executed by the processor, cause the UE to set a DRX timer, the duration of which is dependent on UL-DL configurations of a plurality of aggregated cells, including the first and second cells, such that the duration of the timer corresponds to a number of subframes where at least one of the plurality of aggregated cells has a DL subframe. According to this aspect, the carrier aggregation also comprises at least one cell which is not a scheduling cell, which cell is not included in the plurality of aggregated cells which the duration of the timer is dependent on. The non-scheduling cell may e.g. be a deactivated cell, or an otherwise not scheduling cell.

According to another aspect of the present disclosure, there is provided a method of a network node serving a UE using DRX and TDD carrier aggregation of at least a first and a second cell, the first cell having an UL-DL configuration of UL and DL subframes which is different from such an UL-DL configuration of the second cell. The method comprises setting a DRX timer, the duration of which is dependent on UL-DL configurations of a plurality of aggregated cells of the UE, including the first and second cells, such that the duration of the timer corresponds to a number of subframes where at least one of the plurality of aggregated cells has a DL subframe.

According to this aspect, the carrier aggregation also comprises at least one cell which is not a scheduling cell, which cell is not included in the plurality of aggregated cells which the duration of the timer is dependent on. The non-scheduling cell may e.g. be a deactivated cell, or an otherwise not scheduling cell.

According to another aspect of the present disclosure, there is provided a network node configured serving a UE using DRX and TDD carrier aggregation of at least a first and a second cell, wherein the first cell can have an UL-DL configuration of UL and DL subframes which is different from such an UL-DL configuration of the second cell. The network node comprises a processor, and a memory storing instructions that, when executed by the processor, cause the network node to set a DRX timer, the duration of which is dependent on UL-DL configurations of a plurality of aggregated cells of the UE, including the first and second cells, such that the duration of the timer corresponds to a first number of subframes where at least one of the plurality of aggregated cells has a DL subframe. According to this aspect, the carrier aggregation also comprises at least one cell which is not a scheduling cell, which cell is not included in the plurality of aggregated cells which the duration of the timer is dependent on. The non-scheduling cell may e.g. be a deactivated cell, or an otherwise not scheduling cell.

In the above aspects of the present disclosure where the carrier aggregation comprises a non-scheduling or deactivated cell, a second DRX timer may of may not be set, depending on the situation. It is advantageous not to include the non-scheduling or deactivated cell in the plurality of aggregated cells on which the duration of the (first) timer depends, since PDCCH cannot be scheduled on a non-scheduling or deactivated cell.

In some embodiments, the first DRX timer is an On-Duration timer or an Inactivity timer. For these timers the DL subframes of all the plurality of aggregated cells may be relevant.

In some embodiments, the second DRX timer is a Retransmission timer or a hybrid automatic repeat request, HARQ, round trip time, RTT, timer. For these timers the DL subframes of only one of the aggregated cells may be relevant. The configuration of other devices may be relevant to the RTT timer and the retransmission timer, but only one cell of the aggregated cells.

In some embodiments, a method comprises setting a DRX On-Duration timer, the duration of which is dependent the UL-DL configurations of the plurality of aggregated cells and corresponds to a number of subframes where at least one of the plurality of aggregated cells has a DL subframe.

In some embodiments, a method comprises setting a DRX Inactivity timer, the duration of which is dependent the UL-DL configurations of the plurality of aggregated cells and corresponds to a number of subframes where at least one of the plurality of aggregated cells has a DL subframe.

In some embodiments, a method comprises setting a DRX Retransmission timer, the duration of which is dependent on the UL-DL configuration of a single one of the first and second cells and corresponds to a number of subframes where said single one of the cells has a DL subframe. Said single one of the cells may conveniently be the cell where an HARQ transmission is scheduled, i.e. the cell where an initial HARQ transmission which prompted the setting of the timer was scheduled.

In some embodiments, a method comprises setting an HARQ RTT timer, the duration of which is dependent on the UL-DL configuration of a single one of the first and second cells and corresponds to a number of subframes where said single one of the cells has a DL subframe. Said single one of the cells may conveniently be the cell where an HARQ transmission is scheduled, i.e. the cell where an initial HARQ transmission which prompted the setting of the timer was scheduled.

In some embodiments, the carrier aggregation also comprises at least one deactivated cell which is not included in the plurality of aggregated cells which the duration of the first timer is dependent on. DL subframes configured on a deactivated cell may not be relevant for a DRX timer.

In some embodiments, the carrier aggregation also comprises at least one cell which is not a scheduling cell, which cell is not included in the plurality of aggregated cells which the duration of the first timer is dependent on. DL subframes configured on a non-scheduling cell may not be relevant for a DRX timer.

In some embodiments, a physical downlink control channel (PDCCH) received in a DL subframe of the first cell, schedules another of the aggregated cells. Thus, one of the aggregated cells may be used to schedule another of the aggregated cells.

In some embodiments, the first cell is a primary cell, PCell, and the second cell is a secondary cell, SCell.

In some embodiments, the carrier aggregation is an inter-band carrier aggregation. Due to interference of simultaneous UL and DL on adjacent channels, 3GPP has not standardized intra-band CA in the scenario where the TDD UL-DL configuration is different for the different aggregated carriers.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second” etc. for different features/components of the present disclosure are only intended to distinguish the features/components from other similar features/components and not to impart any order or hierarchy to the features/components.

### BRIEF DESCRIPTION OF THE DRAWINGS

The invention is now described, by way of example, with reference to the accompanying drawings, in which:

FIG. 1 is a schematic block diagram illustrating the difference between FDD and TDD.

FIG. 2 is a schematic block diagram illustrating how a radio frame is divided into subframes in FDD and TDD.

FIG. 3 is a schematic block diagram illustrating different UL-DL configurations available in LTE.

FIG. 4 is a schematic block diagram of UL and DL subframes of a primary cell and a secondary cell which are aggregated.

FIG. 5 is a schematic block diagram of UL and DL subframes of first and second aggregated cells and an embodiment of first and second DRX timers according to the present disclosure.

FIG. 6 is a schematic block diagram of an embodiment of a UE of the present disclosure.

FIG. 7 is a schematic block diagram of an embodiment of a network node of the present disclosure.

FIG. 8 is a schematic diagram illustrating an embodiment of a computer program product of the present disclosure.

FIG. 9 is a schematic flow chart of an embodiment of a method of the present disclosure.

FIG. 10 is a schematic flow chart of another embodiment of a method of the present disclosure.

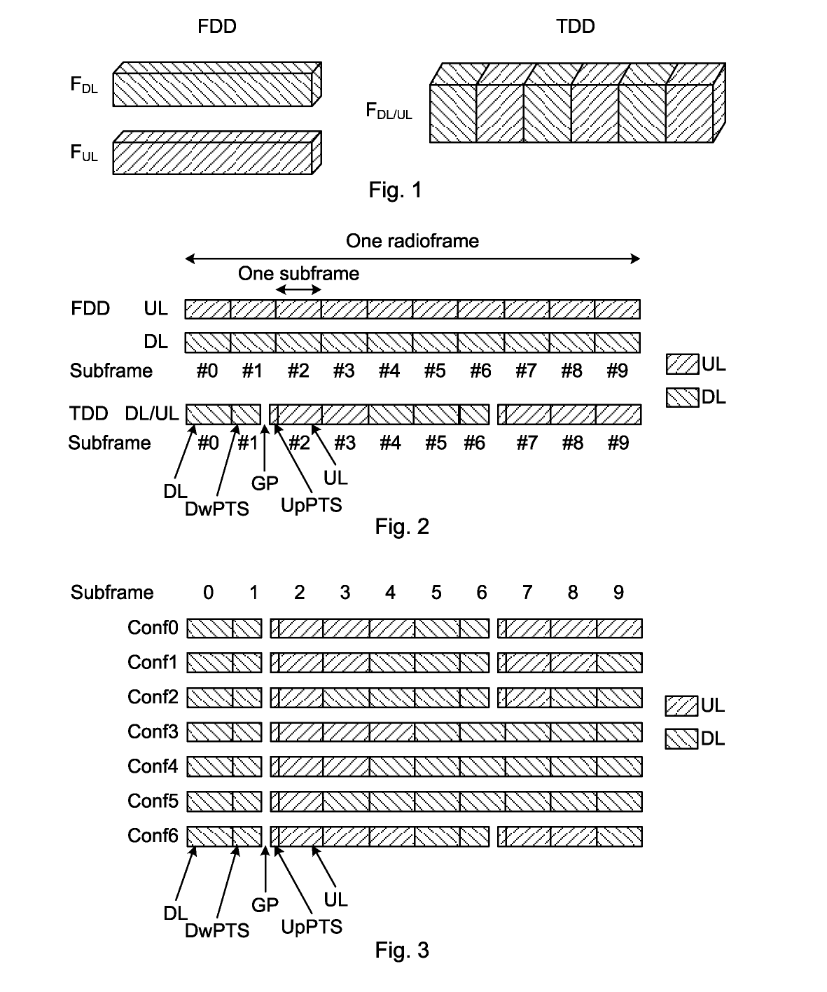

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

The inventors have realised that there are some potential problems associated with the prior art of the R2-115823 contribution. The problems are:

1. Activation status of SCells is not taken into account. If all cells are considered, the scheduling opportunities can be limited due to deactivated SCells.
2. Only scheduling cells can provide scheduling information. If all cells are considered, the scheduling opportunities can be limited due to non-scheduling SCells.
3. In carrier aggregation, HARQ retransmissions can be performed only in the cell where initial transmission was performed. If all cells are considered for the HARQ process specific DRX timers, the scheduling opportunities can be limited.

The above mentioned problems are at least partly solved by different embodiments in the present disclosure.

According to some embodiments of the present disclosure, a scheme for DRX in TDD inter-band carrier aggregation is proposed. In the scheme, the PDCCH subframe is specified as a union of PDCCH subframes of activated scheduling cells in the case timers are common for all HARQ processes. For the timers that are specific for a particular HARQ process, the PDCCH subframe refers to the subframe of the cell where corresponding HARQ transmission is performed.

A DRX timer is generally set to a number of milliseconds or subframes (in LTE this is the same since 1 subframe is 1 ms). As discussed above, only DL subframes (subframes where PDCCH messages can be received), including the DwPTS subframes, are counted for the timer. A timer set to 3 ms thus runs for a duration covering three DL subframes, regardless of how many UL subframes are between the DL subframes. The duration in real time can thus be longer than the 3 ms the timer is set to. Here the term “DL subframe” is used to indicate that a cell has a DL configuration in a subframe of a radio frame, there being e.g. ten subframes (0-9) per radio frame in LTE, as mentioned above.

According to some embodiments of the present disclosure, a first timer is set such that its (real time) duration is dependent on the union of DL subframes of a plurality of the aggregated cells. Thus, if at least one of the plurality of cells is configured for DL in a subframe, that subframe is counted towards the first timer, regardless of whether any other cells are configured for UL in the same subframe. This approach for setting a DRX timer is used for timers where all of the plurality of cells are relevant, e.g. for an On-Duration timer and/or an Inactivity timer.

Further, according to some embodiments of the present disclosure, a second timer is set such that its (real time) duration is depending on only one of the aggregated cells. Thus, only DL subframes of that single cell count towards the second timer, regardless of whether other of the aggregated cells are configured for DL or UL in the subframes. This approach for setting a DRX timer is used for timers where only one of the cells is relevant, e.g. for a Retransmission Timer or an HARQ round trip time (RTT) timer.

In Rel-10, PDCCH subframes in DRX timers are not related at all to activation status of SCells (activated or deactivated). This is natural since when TDD configurations are the same over all cells, it does not make any difference if the SCell is activated or not. The PCell is always activated and any subframe which is PDCCH subframe (i.e. a DL subframe) in one Scell is always an active PDCCH subframe in the PCell. However, in 3GPP Release ii (Rel-ii) where UL/DL subframe occurrence is not synchronous between the SCells and the PCell, it can be that, in a subframe, the PCell has UL phase whereas SCells are in DL phase but are deactivated. If the DRX timers are counted over deactivated cells, scheduling opportunities can be limited. Thus in some embodiments of the present disclosure, we consider that only PDCCH subframes (DL subframes) of activated SCells are considered when counting PDCCH subframes for DRX timers.

The gain of this approach is illustrated with a following example: The UE is configured with one PCell and some SCells semi-statically. However, because the traffic rate from/to the UE is low, some Scells are deactivated to save both cell resources and UE batteries. Now, the eNB wants to schedule the UE in the Pcell. If activation/deactivation status of the Scells is not considered, the scheduling time is limited because it might be that during OnDuration there are only few (or even zero) PDCCH subframes in the Pcell but many PDCCH subframes in the deactivated Scell that cannot be used without activating the SCell. Thus it may be preferable to count only activated SCells.

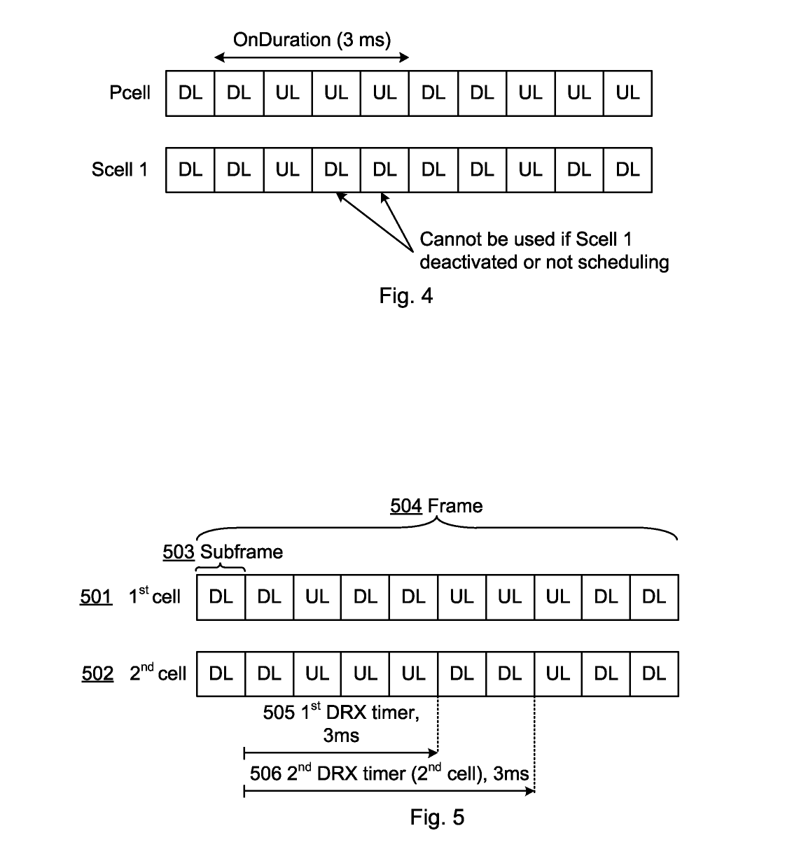

In the example of FIG. 4, the OnDuration timer is 3 ms. In normal FDD/TDD operation this would mean that there are 3 DL subframes time to schedule the UE. In TDD inter-band carrier aggregation scenario, there are less subframes if PDCCH subframes of deactivated Scells “eat” scheduling opportunities. Of course, this can be compensated by longer timer values of the timer but since the scenario changes dynamically, longer timer values come with cost of battery consumption. In addition, having different timer values for different RRC configurations may be a bit complex.

In Rel-10, the scenario of FIG. 4 is not possible in FDD or in TDD since 1) DL subframes occur at same time in all cells and 2) the Pcell is always activated so it is always possible to schedule the UE in the Pcell during a subframe which is part of DRX Active Time.

Similar to activation status of SCells, in Rel-10, it is not taken into account if the cell is a scheduling cell or not, because the PCell is anyway always activated. However, because only a scheduling cell can carry PDCCH for the SCell, in the present disclosure, only scheduling cells are taken into account when PDCCH subframes for DRX timers are counted. Reference is again made to FIG. 4, where it is illustrated that the DL subframes of the SCell cannot be used for PDCCH if the SCell is deactivated or not a scheduling cell, why it is in some embodiments undesirable to count the DL subframes of the SCell towards the On-Duration Timer.

Thus, the plurality of aggregated cells discussed herein, e.g. in relation to the first DRX timer, may exclude any of the aggregated cells which are deactivated and/or not scheduling cell used to schedule another cell, that is, cross-carrier scheduling.

In some embodiments, one set of DRX timers is specified in such away that PDCCH-subframes over all aggregated carriers, or all aggregated active and/or scheduling carriers/cells, are taken into account when counting the length/duration of the timer. Furthermore, only activated scheduling SCells should be considered. In one non-limiting embodiment of the present disclosure, the timers that are specified in this way are drx-OnDurationTimer and drx-InactivityTimer.

In some embodiments, another set of DRX timers are specified in such away that PDCCH-subframes of one particular cell are taken into account when counting the length/duration of the timer. The timers that are HARQ process specific can be counted like this. Examples of such timers are drx-RetransmissionTimer and HARQ RTT Timer. It is contemplated that a plurality of such timers can run concurrently, each for a different one of the aggregated cells.

FIG. 5 schematically illustrates a radio frame 504 of first 501 and second 502 aggregated cells. The frame 504 is divided into ten subframes 503. In each subframe 503, each of the cells 501 and 502 has either an UL or DL configuration (UL or DL subframe). The special subframes comprising the DwPTS is regarded as DL subframes since the PDCCH can be transmitted therein. A first DRX timer 505 is set for 3 ms (which is the same as three DL subframes, as discussed above). The duration in real time of the first DRX timer depends on/corresponds to the three subframes from the start of the timer where at least one of the first and second cells has a DL subframe. In the example of FIG. 5, the second subframe after start of the timer 505 lacks a DL subframe (could alternatively be called DL configuration) in either of the cells 501 and 502, whereas the first, third and fourth subframes has a DL subframe in either of the cells 501 and 502 (in both cells in the first subframe after start of the timer, in the first cell in the third subframe and in the first cell in the fourth subframe). Thus the real time duration of the first timer is 4 ms, since the timer is set to 3 ms and one subframe during its duration lacked a DL subframe in all the aggregated cells 501 and 502. A second DRX timer 506 is also set to 3 ms (which is the same as three DL subframes, as discussed above). The second timer is only related to the second cell 502, e.g. only relates to a HARQ procedure for the second cell. Thus, the duration in real time of the second DRX timer depends on/corresponds to the three subframes from the start of the timer where the second cells 502 has a DL subframe. For the second timer duration, it is not relevant what UL-DL configuration the first cell 501 has. In the example of FIG. 5, the second, third and fourth subframes after start of the timer 506 lacks a DL subframe in the second cell 502, whereas in the first, fifth and sixth subframes the second cell 502 has a DL subframe. Thus the real time duration of the second timer 506 is 6 ms, since the timer is set to 3 ms and three subframe during its duration lacked a DL subframe in the second cell 502. In FIG. 5, only two aggregated cells/carriers are shown, but any number of cells can be aggregated within the scope of the present disclosure.

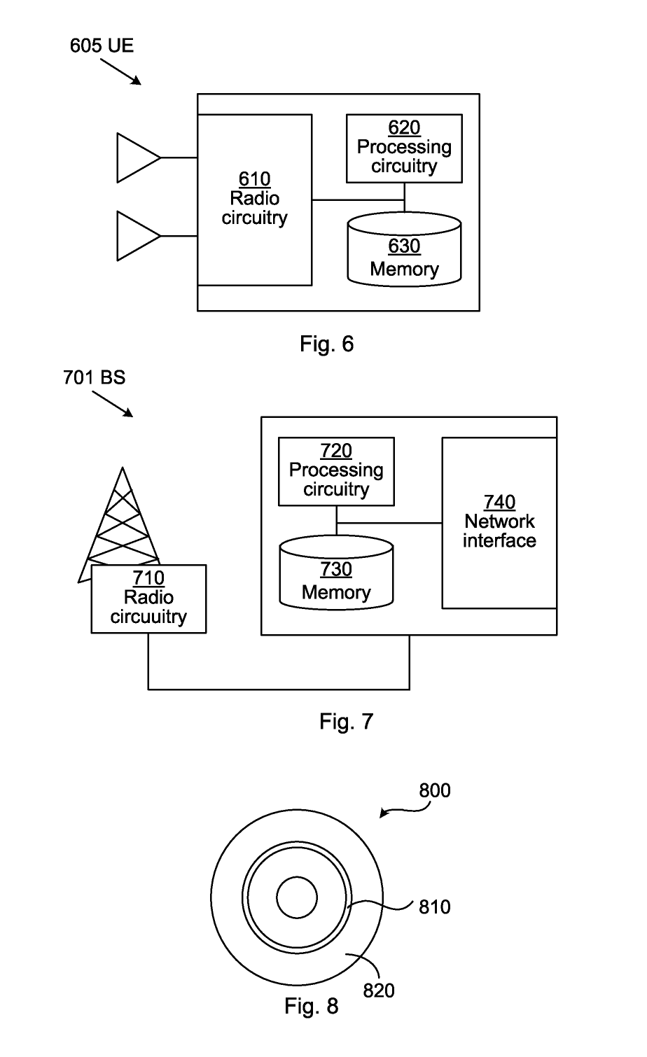

The example embodiments presented herein may be utilized in a radio network, which may further comprise network nodes such as a network node in the form of a base station 701 and/or a user equipment 605, as illustrated in FIGS. 6 and 7, respectively.

An example of a user equipment is provided in FIG. 6. The example wireless user equipment 605 may comprise processing circuitry 620, a memory 630, radio circuitry 610, and at least one antenna. The radio circuitry may comprise RF circuitry and baseband processing circuitry (not shown). In particular embodiments, some or all of the functionality described above as being provided by mobile communication devices or other forms of wireless device may be provided by the processing circuitry 620 executing instructions stored on a computer-readable medium, such as the memory 630 shown in FIG. 6. Alternative embodiments of the user equipment 605 may comprise additional components responsible for providing additional functionality, comprising any of the functionality identified above and/or any functionality necessary to support the solution described above.

The UE 605 may be any radio device, mobile or stationary, enabled to communicate over the radio cannel in the communications network, for instance but not limited to e.g. mobile phone, smart phone, sensors, meters, vehicles, household appliances, medical appliances, media players, cameras, or any type of consumer electronic, for instance but not limited to television, radio, lighting arrangements, tablet computer, laptop, or PC.

As shown in FIG. 7, the example base station 701 may comprise processing circuitry 720, a memory 730, radio circuitry 710, and at least one antenna port for connecting to a corresponding antenna. The processing circuitry 720 may comprise RF circuitry and baseband processing circuitry (not shown). In particular embodiments, some or all of the functionality described above as being provided by a mobile base station, a base station controller, a relay node, a NodeB, an enhanced NodeB, and/or any other type of mobile communications node may be provided by the processing circuitry 720 executing instructions stored on a computer-readable medium, such as the memory 730 shown in FIG. 7. Alternative embodiments of the base station 701 may comprise additional components responsible for providing additional functionality, comprising any of the functionality identified above and/or any functionality necessary to support the solution described above.

It should also be appreciated that the base station 701 illustrated in FIG. 7 may be configured to determine the duration of the DRX active period based on those of the SCells that are active in addition to the PCell (which may always be active), such that the active period will embrace the PDCCH subframes occasions of the active cells while neglect the PDCCH subframe occasions of any SCell that is not activated with respect to the particular user equipment.

FIG. 8 illustrates a computer program product 800. The computer program product 800 comprises a computer readable medium 820 comprising a computer program in the form of computer-executable components 810. The computer program/computer-executable components 810 may be configured to cause a device 1, e.g. a UE or a network node as discussed above to perform an embodiment of a method of the present disclosure. The computer program/computer-executable components may be run on the processing unit 620 or 720 of the device, such as the UE 605 or network node 701, for causing the device to perform the method. The computer program product 800 may e.g. be comprised in a storage unit or memory 630 or 730 comprised in the device and associated with the processing unit 620 or 720. Alternatively, the computer program product 800 may be, or be part of, a separate, e.g. mobile, storage means, such as a computer readable disc, e.g. CD or DVD or hard disc/drive, or a solid state storage medium, e.g. a RAM or Flash memory.

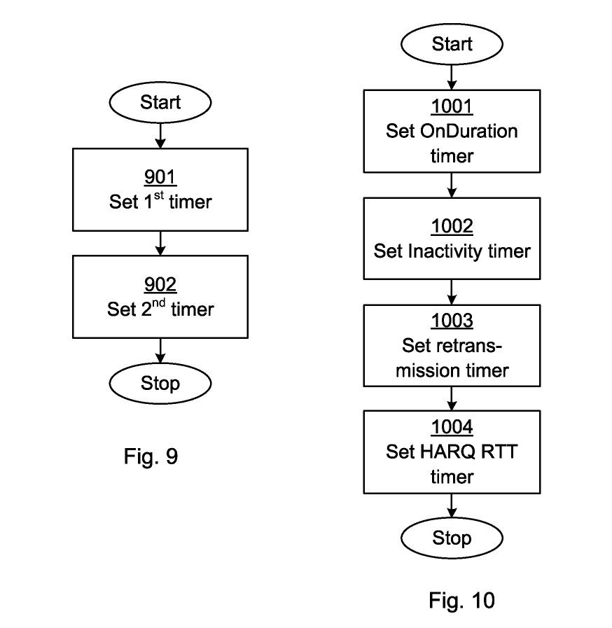

FIG. 9 is a schematic flow chart of an embodiment of a method of the present disclosure. A first DRX timer 505 is set 901. The duration of the first DRX timer 505 is dependent on UL-DL configurations of a plurality of aggregated cells, including the first and second cells 501, 502, such that the duration of the first timer corresponds to a first number of subframes 503 where at least one of the plurality of aggregated cells has a DL subframe. A second DRX timer 506 is set 902. The duration of the second timer is dependent on the UL-DL configuration of a single one of the aggregated cells 501 or 502, such that the duration of the second timer corresponds to a second number of subframes 503 where said single one of the cells has a DL subframe. The method may be performed e.g. by a UE and/or by a network node, as discussed herein.

FIG. 10 is a schematic flow chart of another embodiment of a method of the present disclosure. According to this embodiment, the first DRX timer 505 can be an On-Duration Timer and/or an Inactivity Timer, whereas the second DRX timer 506 can be a Retransmission Timer and/or an HARQ RTT timer. An On-Duration timer is set 1001. The duration of the On-Duration timer is dependent on UL-DL configurations of a plurality of aggregated cells, including the first and second cells 501, 502, such that the duration of the timer corresponds to a number of subframes 503 where at least one of the plurality of aggregated cells has a DL subframe. An Inactivity timer is set 1002. The duration of the Inactivity timer is dependent on UL-DL configurations of a plurality of aggregated cells, including the first and second cells 501, 502, such that the duration of the timer corresponds to a number of subframes 503 where at least one of the plurality of aggregated cells has a DL subframe. A Retransmission timer is set 1003. The duration of the Retransmission timer is dependent on the UL-DL configuration of a single one of the aggregated cells 501 or 502, such that the duration of the timer corresponds to a number of subframes 503 where said single one of the cells has a DL subframe. An HARQ RTT timer is set 1004. The duration of the HARQ RTT timer is dependent on the UL-DL configuration of a single one of the aggregated cells 501 or 502, such that the duration of the timer corresponds to a number of subframes 503 where said single one of the cells has a DL subframe.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

A “device” as the term is used herein, is to be broadly interpreted to include a radiotelephone having ability for Internet/intranet access, web browser, organizer, calendar, a camera (e.g., video and/or still image camera), a sound recorder (e.g., a microphone), and/or global positioning system (GPS) receiver; a personal communications system (PCS) terminal that may combine a cellular radiotelephone with data processing; a personal digital assistant (PDA) that can include a radiotelephone or wireless communication system; a laptop; a camera (e.g., video and/or still image camera) having communication ability; and any other computation or communication device capable of transceiving, such as a personal computer, a home entertainment system, a television, etc.

Although the description is mainly given for a user equipment, as measuring or recording unit, it should be understood by the skilled in the art that “user equipment” is a non-limiting term which means any wireless device or node capable of receiving in DL and transmitting in UL (e.g. PDA, laptop, mobile, sensor, fixed relay, mobile relay or even a radio base station, e.g. femto base station).

A cell is associated with a radio node, where a radio node or radio network node or eNodeB used interchangeably in the example embodiment description, comprises in a general sense any node transmitting radio signals used for measurements, e.g., eNodeB, macro/micro/pico base station, home eNodeB, relay, beacon device, or repeater. A radio node herein may comprise a radio node operating in one or more frequencies or frequency bands. It may be a radio node capable of CA. It may also be a single- or multi-RAT node. A multi-RAT node may comprise a node with co-located RATs or supporting multi-standard radio (MSR) or a mixed radio node.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Below follow a few additional aspects of the present disclosure.

According to an aspect of the present disclosure, there is provided a user equipment (UE) configured for using DRX and TDD carrier aggregation of at least a first and a second cell, wherein the first cell can have an UL-DL configuration of UL and DL subframes which is different from such an UL-DL configuration of the second cell. The UE comprises means for setting a first DRX timer, the duration of which is dependent on UL-DL configurations of a plurality of aggregated cells, including the first and second cells, such that the duration of the first timer corresponds to a first number of subframes where at least one of the plurality of aggregated cells has a DL subframe. The UE also comprises means for setting a second DRX timer, the duration of which is dependent on the UL-DL configuration of a single one of the aggregated cells, such that the duration of the second timer corresponds to a second number of subframes where said single one of the cells has a DL subframe.

According to another aspect of the present disclosure, there is provided a network node configured for being associated with a UE using DRX and TDD carrier aggregation of at least a first and a second cell, wherein the first cell can have an UL-DL configuration of UL and DL subframes which is different from such an UL-DL configuration of the second cell. The network node comprises means for setting a first DRX timer, the duration of which is dependent on UL-DL configurations of a plurality of aggregated cells of the UE, including the first and second cells, such that the duration of the second timer corresponds to a first number of subframes where at least one of the plurality of aggregated cells has a DL subframe. The network node also comprises means for setting a second DRX timer, the duration of which is dependent on the UL-DL configuration of a single one of the aggregated cells of the UE, such that the duration of the second timer corresponds to a second number of subframes where said single one of the cells has a DL subframe.

According to another aspect of the present disclosure, there is provided a UE configured for using DRX and TDD carrier aggregation of at least a first and a second cell, wherein the first cell can have an UL-DL configuration of UL and DL subframes which is different from such an UL-DL configuration of the second cell. The UE comprises means for setting a DRX timer, the duration of which is dependent on UL-DL configurations of a plurality of aggregated cells, including the first and second cells, such that the duration of the timer corresponds to a number of subframes where at least one of the plurality of aggregated cells has a DL subframe. According to this aspect, the carrier aggregation also comprises at least one cell which is not a scheduling cell, which cell is not included in the plurality of aggregated cells which the duration of the timer is dependent on. The non-scheduling cell may e.g. be a deactivated cell, or an otherwise not scheduling cell.

According to another aspect of the present disclosure, there is provided a network node configured for being associated with a UE using DRX and TDD carrier aggregation of at least a first and a second cell, wherein the first cell can have an UL-DL configuration of UL and DL subframes which is different from such an UL-DL configuration of the second cell. The network node comprises means for setting a DRX timer, the duration of which is dependent on UL-DL configurations of a plurality of aggregated cells of the UE, including the first and second cells, such that the duration of the timer corresponds to a first number of subframes where at least one of the plurality of aggregated cells has a DL subframe. According to this aspect, the carrier aggregation also comprises at least one cell which is not a scheduling cell, which cell is not included in the plurality of aggregated cells which the duration of the timer is dependent on. The non-scheduling cell may e.g. be a deactivated cell, or an otherwise not scheduling cell.

The invention has mainly been described above with reference to a few embodiments. However, as is readily appreciated by a person skilled in the art, other embodiments than the ones disclosed above are equally possible within the scope of the invention, as defined by the appended patent claims.

1-20. (canceled)

21. A method of a user equipment (UE) using discontinuous reception (DRX) and time division duplex (TDD) carrier aggregation of at least a first and a second cell, the first cell having an UL-DL configuration of uplink (UL) and downlink (DL) subframes that differs from an UL-DL configuration of the second cell, the method comprising:
setting a first DRX timer, the duration of which is dependent on UL-DL configurations of a plurality of aggregated cells, including the first and second cells, such that the duration of the first timer corresponds to a first number of subframes where at least one of the plurality of aggregated cells has a DL subframe; and
setting a second DRX timer, the duration of which is dependent on the UL-DL configuration of a single one of the aggregated cells, such that the duration of the second timer corresponds to a second number of subframes where said single one of the cells has a DL subframe.

22. The method of claim 21, wherein the first DRX timer is an On-Duration timer or an Inactivity timer.

23. The method of claim 21, wherein the second DRX timer is a Retransmission timer or a hybrid automatic repeat request (HARQ) round trip time (RTT) timer.

24. The method of claim 21, wherein the method comprises:
setting a DRX On-Duration timer, the duration of which is dependent on the UL-DL configurations of the plurality of aggregated cells and corresponds to a number of subframes where at least one of the plurality of aggregated cells has a DL subframe;
setting a DRX Inactivity timer, the duration of which is dependent on the UL-DL configurations of the plurality of aggregated cells and corresponds to a number of subframes where at least one of the plurality of aggregated cells has a DL subframe;
setting a DRX Retransmission timer, the duration of which is dependent on the UL-DL configuration of a single one of the first and second cells and corresponds to a number of subframes where said single one of the cells has a DL subframe; and
setting an HARQ RTT timer, the duration of which is dependent on the UL-DL configuration of a single one of the first and second cells and corresponds to a number of subframes where said single one of the cells has a DL subframe.

25. The method of claim 21, wherein the carrier aggregation also comprises at least one deactivated cell that is not included in the plurality of aggregated cells upon which the duration of the first timer depends.

26. The method of claim 21, wherein the carrier aggregation also comprises at least one cell which is not a scheduling cell, which cell is not included in the plurality of aggregated cells upon which the duration of the first timer depends.

27. The method of claim 21, wherein a physical downlink control channel (PDCCH) received in a DL subframe of the first cell, schedules another of the aggregated cells.

28. The method of claim 21, wherein the first cell is a primary cell (PCell) and the second cell is a secondary cell (SCell).

29. The method of claim 21, wherein the carrier aggregation is an inter-band carrier aggregation.

30. A user equipment (UE) configured for using discontinuous reception (DRX) and time division duplex (TDD) carrier aggregation of at least a first and a second cell, wherein the first cell can have an UL-DL configuration of uplink (UL) and downlink (DL) subframes that is different from an UL-DL configuration of the second cell, the UE comprising:
a processor; and
a memory storing instructions that, when executed by the processor, cause the UE to:
set a first DRX timer, the duration of which is dependent on UL-DL configurations of a plurality of aggregated cells, including the first and second cells, such that the duration of the first timer corresponds to a first number of subframes where at least one of the plurality of aggregated cells has a DL subframe; and
set a second DRX timer, the duration of which is dependent on the UL-DL configuration of a single one of the aggregated cells, such that the duration of the second timer corresponds to a second number of subframes where said single one of the cells has a DL subframe.

31. A non-transitory computer-readable medium comprising thereupon a computer program for a user equipment (UE) configured for using discontinuous reception (DRX) and time division duplex (TDD) carrier aggregation of at least a first and a second cell, wherein the first cell can have an UL-DL configuration of uplink (UL) and downlink (DL) subframes which is different from such an UL-DL configuration of the second cell, the computer program comprising computer program code configured to, when run on a processor of the UE, cause the UE to:
set a first DRX timer, the duration of which is dependent on UL-DL configurations of a plurality of aggregated cells, including the first and second cells, such that the duration of the first timer corresponds to a first number of subframes where at least one of the plurality of aggregated cells has a DL subframe; and
set a second DRX timer, the duration of which is dependent on the UL-DL configuration of a single one of aggregated cells, such that the duration of the second timer corresponds to a second number of subframes where said single one of the cells has a DL subframe.

32. A method of a network node serving a user equipment (UE) using discontinuous reception (DRX) and time division duplex (TDD) carrier aggregation of at least a first and a second cell, the first cell having an UL-DL configuration of uplink (UL) and downlink (DL) subframes that differ from an UL-DL configuration of the second cell, the method comprising:
setting a first DRX timer, the duration of which is dependent on UL-DL configurations of a plurality of aggregated cells of the UE, including the first and second, such that the duration of the first timer corresponds to a first number of subframes where at least one of the plurality of aggregated cells has a DL subframe; and
setting a second DRX timer, the duration of which is dependent on the UL-DL configuration of a single one of the aggregated cells of the UE, such that the duration of the second timer corresponds to a second number of subframes where said single one of the cells has a DL subframe.

33. A network node configured for serving a user equipment (UE) using discontinuous reception (DRX) and time division duplex (TDD) carrier aggregation of at least a first and a second cell, wherein the first cell can have an UL-DL configuration of uplink (UL) and downlink (DL) subframes that differs from an UL-DL configuration of the second cell, the network node comprising:
a processor; and
a memory storing instructions that, when executed by the processor, cause the network node to:
set a first DRX timer, the duration of which is dependent on UL-DL configurations of a plurality of aggregated cells of the UE, including the first and second cells, such that the duration of the first timer corresponds to a first number of subframes where at least one of the plurality of aggregated cells has a DL subframe; and
set a second DRX timer, the duration of which is dependent on the UL-DL configuration of a single one of the aggregated cells of the UE, such that the duration of the second timer corresponds to a second number of subframes where said single one of the cells has a DL subframe.

34. A method of a user equipment (UE) using discontinuous reception (DRX) and time division duplex (TDD) carrier aggregation of at least a first and a second cell, the first cell having an UL-DL configuration of uplink (UL) and downlink (DL) subframes that differs from an UL-DL configuration of the second cell, the method comprising:
setting a DRX timer, the duration of which is dependent on UL-DL configurations of a plurality of aggregated cells, including the first and second cells, such that the duration of the timer corresponds to a number of subframes where at least one of the plurality of aggregated cells has a DL subframe;
wherein the carrier aggregation also comprises at least one cell which is not a scheduling cell, which cell is not included in the plurality of aggregated cells which the duration of the timer is dependent on.

35. The method of claim 34, wherein the non-scheduling cell is a deactivated cell.

36. A user equipment (UE) configured for using discontinuous reception (DRX) and time division duplex (TDD) carrier aggregation of at least a first and a second cell, wherein the first cell can have an UL-DL configuration of uplink (UL) and downlink (DL) subframes that differs from an UL-DL configuration of the second cell, the UE comprising:
a processor; and
a memory storing instructions that, when executed by the processor, cause the UE to:
set a DRX timer, the duration of which is dependent on UL-DL configurations of a plurality of aggregated cells, including the first and second cells, such that the duration of the timer corresponds to a number of subframes where at least one of the plurality of aggregated cells has a DL subframe;
wherein the carrier aggregation also comprises at least one cell which is not a scheduling cell, which non-scheduling cell is not included in the plurality of aggregated cells which the duration of the timer is dependent on.

37. A method of a network node serving a user equipment (UE) using discontinuous reception (DRX) and time division duplex (TDD) carrier aggregation of at least a first and a second cell, the first cell having an UL-DL configuration of uplink (UL) and downlink (DL) subframes that differs from an UL-DL configuration of the second cell, the method comprising:
setting a DRX timer, the duration of which is dependent on UL-DL configurations of a plurality of aggregated cells of the UE, including the first and second cells, such that the duration of the timer corresponds to a number of subframes where at least one of the plurality of aggregated cells has a DL subframe;
wherein the carrier aggregation also comprises at least one cell which is not a scheduling cell, which non-scheduling cell is not included in the plurality of aggregated cells which the duration of the timer is dependent on.

38. A network node configured for serving a user equipment (UE) using discontinuous reception (DRX) and time division duplex (TDD) carrier aggregation of at least a first and a second cell, wherein the first cell can have an UL-DL configuration of uplink (UL) and downlink (DL) subframes that differs from an UL-DL configuration of the second cell, the network node comprising:
a processor; and
a memory storing instructions that, when executed by the processor, cause the network node to:
set a first DRX timer, the duration of which is dependent on UL-DL configurations of a plurality of aggregated cells of the UE, including the first and second cells, such that the duration of the second timer corresponds to a first number of subframes where at least one of the plurality of aggregated cells has a DL subframe;
wherein the carrier aggregation also comprises at least one cell which is not a scheduling cell, which non-scheduling cell is not included in the plurality of aggregated cells which the duration of the timer is dependent on.
